(19) United States
(12) Patent Application Publication
(10) Pub. No.: US 2008/0239235 A1
(43) Pub. Date: Oct. 2, 2008

(54) EYEWEAR WITH INTEGRATED BOTTLE CAP OPENER

(76) Inventor: David Thomas Severino, Pacific Palisades, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/692,396

(22) Filed: Mar. 28, 2007

(51) Int. Cl. G02C 11/00

(52) U.S. Cl. 351/158

(57) ABSTRACT

Eyewear has a frame front and a temple connected to the frame front at a corner. The temple has an earpiece and a tip, one of which has a mechanism integrated therein for removing bottle caps. In another embodiment, the bottle cap removing mechanism is embedded in the temple between the earpiece and the corner. Other embodiments are also described and claimed.

### BACKGROUND

Bottle caps are used to seal the openings of bottles. For glass bottles, they are typically small circular pieces of metal with plastic backings, and for plastic bottles a plastic cap is typically used instead. A bottle cap is typically colorfully decorated with the logo of the brand of beverage.

Bottle caps were originally designed to be pressed over and around the top of a glass bottle to grab a small flange on the bottleneck. The Crown Cork was patented by William Painter, on Feb. 2, 1892 (U.S. Pat. No. 468,258). It originally had 24 teeth and a cork seal with a paper backing to prevent contact between the contents and the metal cap. The current version has 21 teeth. To open these bottles, a bottle opener or bottle cap remover is typically required.

The height of the crown cap was reduced and specified in the German standard DIN 6099 in the 1960s. This also defined the “twist-off” crown cap, now widely used in the United States. This bottle cap is pressed around screw threads instead of a flange. Such a bottle cap can be taken off merely by twisting the cap.

As mentioned above, a bottle opener is a device that enables the removal of metal bottle caps from bottles. The metal bottle cap is affixed to the rim of the neck of a bottle by being pleated or ruffled around the rim. A bottle opener is a specialized lever inserted beneath the pleated metalwork, which uses a point on the bottle cap as a fulcrum on which to pivot.

There are several distinct designs of bottle openers. There are wall mounted openers that are typically found behind bars in pubs. Examples of hand-tool bottle openers are those that are found as part of a waiter's friend (where the bottle opener is integrated into a piece that doubles as a cork removal lever), a Swiss army knife, and a bar blade. Relatively compact bottle openers have also been attached to key rings.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a left side view of eyewear that is in accordance with a first embodiment of the invention.

FIG. 2 is a left side view of a second embodiment of the invention.

FIG. 3 is a close-up view of a third embodiment of the invention.

FIG. 4 is a right side view of eyewear that is in accordance with a fourth embodiment of the invention.

### DETAILED DESCRIPTION

In this section we shall explain several preferred embodiments of this invention with reference to the appended drawings. Whenever the shapes, relative positions and other aspects of the parts described in the embodiments are not clearly defined, the scope of the invention is not limited only to the parts shown, which are meant merely for the purpose of illustration.

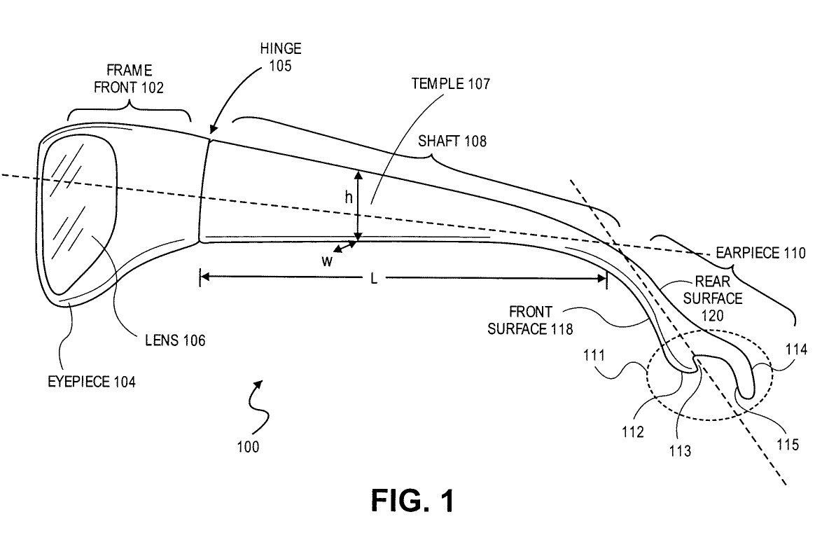

The various embodiments of the invention aim to make it easier for a person to have access to a bottle opener that has been integrated into eyewear in a discrete manner. Different embodiments of eyewear with an integrated bottle opener are described. Beginning with FIG. 1, a first embodiment of the invention is shown by its side view. Eyewear 100 in the form of, in this example, sunglasses is shown as having a frame front 102. In the preferred embodiment, the periphery of the frame front or rim is substantially coextensive with first and second eye orbital regions of an average person. The specific extent of the periphery is variable, and depends on certain aesthetic factors, such as the size of the frame front. The frame front 102 preferably has a pair of eyepieces that are aligned with the orbitals, respectively. Each eyepiece in this case holds a separate lens. Although not shown in FIG. 1, the frame front of this embodiment also has a bridge that connects the two eyepieces and rests on the wearer's nose. As an alternative, the frame front 102 may have a shield type design where there is a single, large lens that is mounted in the frame front and extends from one side of the wear's face to the other. In yet a further alternative, a wrap design may be adopted where the lens curves around the side of the wearer's head (in order to protect against sun and glare entering into the side of the eye). In all instances, at least one temple 107, and preferably a pair, is connected to the frame front 102 at a corner, preferably by a respective hinge 105.

The hinge 105 is used to connect the temple 107 to the frame front 102 at the corner, while allowing the temple 107 to fold flat against the frame. The hinge may have two parts that are connected to each other at a pivot point, where one part is affixed to the frame front (at either side of the frame front), and the other is affixed to a front end portion of the temple 107. The hinge 105 may be a spring hinge, or a hinge with spring action, which allows the temple to be pivoted further outward, without breakage of the frame or the temple. Note that in some embodiments, there is no hinge connecting the temple 107 to the side of the frame front 102, so that the temple remains in its “open” position at all times. The corner at which the temple 107 and the frame front 102 are connected to each other may, however, be flexible relative to the frame front 102, to avoid permanent deformation of the eyewear upon accidental impact.

The temple 107 comprises a shaft 108 (whose forward end portion may be hinged) extending back to an earpiece 110. The shaft 108 is often referred to as the middle section of the temple and is a typically straight part that extends from the corner or connection point (e.g., hinge point) at the frame front 102, to an earpiece 110. The shaft typically has a height, H, that is greater than its width or thickness, W, so as to rest comfortably flat against the temple or the wearer's head. Its length, L, is preferably in the range of 3-5 inches. The shaft 108 is not limited to being entirely straight as shown in FIG. 1, i.e. in the same plane as the page; it could instead have a curve. Also, the shaft 108 need not be entirely straight along its longitudinal axis as shown; it instead could have a curve or be composed of multiple straight segments that are at different angles relative to the longitudinal axis.

The earpiece 110 is the section of the temple 107 that goes behind the wearer's ear, and is typically the “bent down” portion. As an alternative, the temple may not have a bend in it. This is referred to as a straight temple. In the embodiments depicted in the figures here, the temples are all normal or skull temples, in which the temple bends down at about a forty-five degree angle at the top of the wearer's ear.

In the embodiment of the invention depicted in FIG. 1, the tip 111 of the temple 107 has an open jaw or mouth (as viewed from the side of the eyewear) that points rearward. The mouth may be deemed substantially U-shaped or V-shaped. Here, the U or V-shaped tip has a lower segment 112 that is shorter than the other, upper segment 114 and resembles a claw. The upper segment 114 is curved downward at its outer end, so that its inside surface 115 can rest against the top of the bottle cap (not shown), at a fulcrum point. The inside surface 113 of the shorter vertical segment 112 hooks onto the bottom edge of the cap (e.g., beneath the pleated metalwork of the cap). This allows the jaw or mouth to grip the bottle cap. The mechanism may be similar to that of a bottle cap opener in a Swiss Army knife. Once the tip of the earpiece 110 has been placed in this position by the user, the bottle cap may be removed to open the bottle, by the user lifting up on the temple, preferably at some point underneath the shaft 108, which pries off the cap.

In the embodiment of FIG. 1, the segment 112 of the tip extends or flows straight from the front surface 118 of the earpiece, whereas the longer segment 114 flows from the rear surface 120. The front and rear surfaces 118, 120 are positioned opposite each other as shown, with the front surface 118 being located closer to the hinge 105 than the rear surface. In that case, the tip is such that its shorter segment 112 is in front of the other segment 114. As an alternative, the earpiece 110 may be designed with its tip 111 rotated 180 degrees about the longitudinal axis of the earpiece 110, such that the shorter segment 112 extends from the rear surface 120, and the longer segment 114 extends from the front surface 118 (not shown).

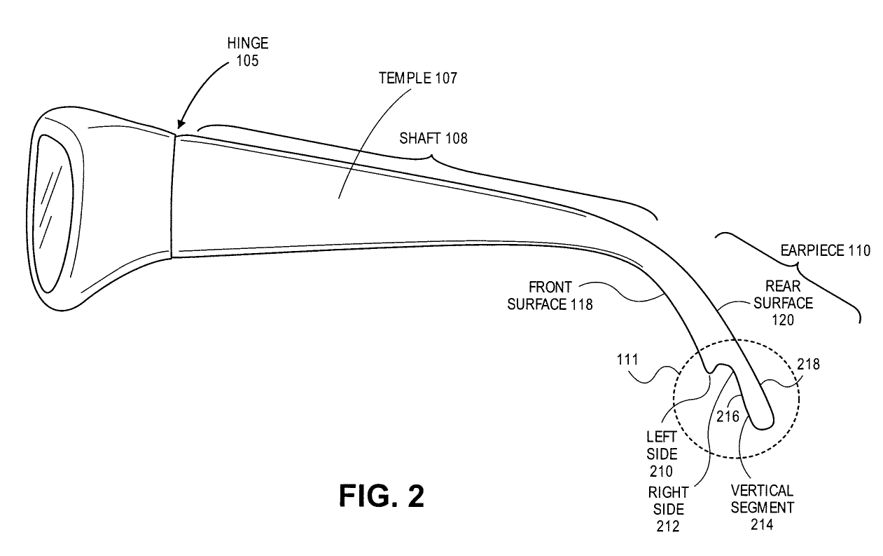

Turning now to FIG. 2, another embodiment of the invention is shown, also as eyewear having an integrated bottle opener. This embodiment also resembles the bottle cap opener blade of a typical Swiss Army knife. In this case, the tip 111 of the earpiece 110 is substantially J-shaped, to grip the bottle cap. The J-shaped tip has a curved segment with a left side 210 and a right side 212 that are separated by a distance slightly greater than the height of a standard bottle cap. This allows the inside of the left side 210 to grip the bottom edge of the cap, while the inside surface of the right side rests against the top of the cap. A vertical segment 214 of the “J” extends from the right side 212. The vertical segment 214 has a left surface 216 that extends from a surface of the curved segment, and a right surface 118 opposite the left surface. The left side 210 of the curved segment may be reinforced relative to the right side 212, where the left side 210 is intended to grip the bottom edge of the cap and may thus be subjected to greater forces during the removal operation.

Also, note that in this embodiment, the left surface 216 of the vertical segment is behind the front surface 118 of the earpiece, and in front of the right surface 218. This is also referred to as the pointing “downwards” embodiment. As an alternative, the J-shaped tip (or hook) may be pointing upwards (not shown), where in that case the right surface 218 is behind the front surface 118 of the earpiece, and in front of the left surface 216. This can be visualized by rotating the tip 111 180 degrees about the longitudinal axis of the earpiece 110, relative to the rest of the temple.

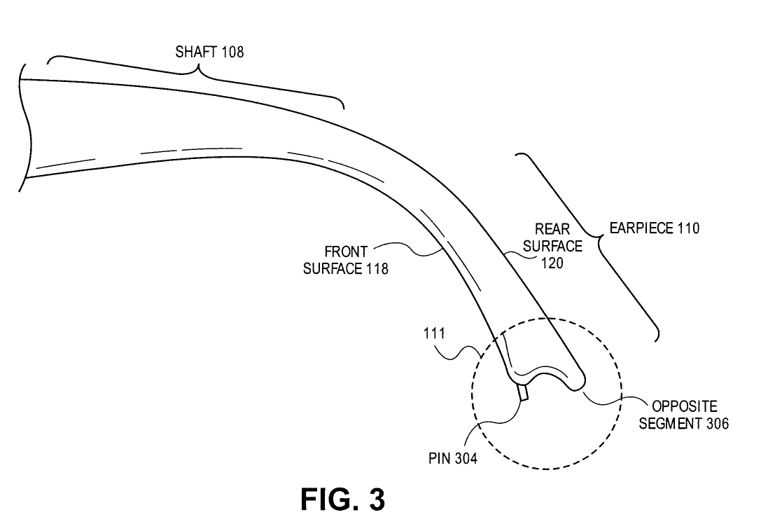

In FIG. 3, yet another embodiment of the invention is depicted. In this case, the tip 111 of the earpiece 110 also has an open jaw or mouth that is substantially U-shaped. One segment of the U-shaped tip has a pin or claw 304 that is positioned and sized to grip the bottom edge of bottle cap, together with the opposite segment 306 of the fork-shaped tip resting against the top of the cap and acting as a fulcrum (when the cap is being pryed off). The spacing between the segments of the U-shaped tip, as well as the length of the opposite segment 306, may be selected in view of the typical height of a conventional bottle cap.

Also note that in FIG. 3, the pin 304 can be said to be pointing “downwards” because the tip 111 is such that the pin 304 is positioned behind the front surface 118 of the earpiece 110, and in front of the opposite segment 306. As an alternative, the pin may be pointing “upwards”, where the pin 304 in that case will be located behind the front surface 118 and also behind the opposite segment 306. This can be visualized by rotating the tip 111 180 degrees about the longitudinal axis of the earpiece 110 (relative to the rest of the temple). Note the pin 304 may be a separately manufactured piece that is embedded into and is of a different material than the segment; alternatively, the pin 304 may be of the same material and integrated with the segment.

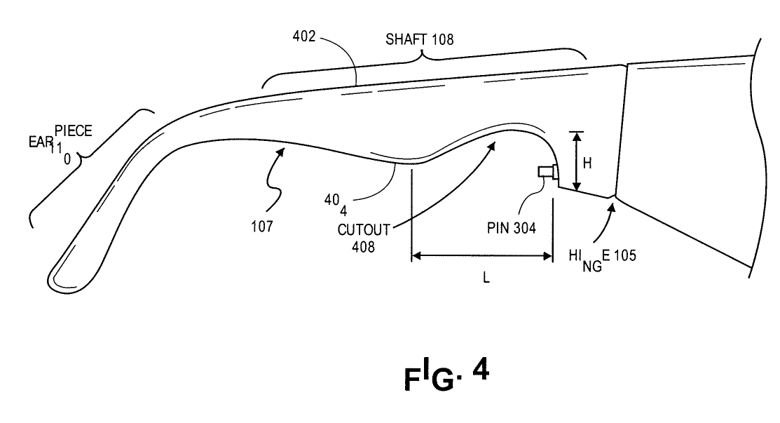

In yet another embodiment depicted in FIG. 4, the eyewear has means for removing a bottle cap that has been embedded in the shaft 108 of temple, between the earpiece 110 and the hinge 105. More particularly, note that the shaft has a top surface 402, and a bottom surface 404 that is opposite the top surface. These top and bottom surfaces 402, 404 are also located between the hinge 105 and the earpiece 110 of the temple. The bottle cap removing means in this embodiment comprises a cutout 408 in the bottom surface 404, and a pin or claw 304 embedded in the portion of the shaft 108 revealed by the cutout 408. The dimensions of the cutout may be in the following ranges: ½″<L<1¼″; ⅛″<H<¾″. The pin 304 is designed to cooperate with the cutout 408, and, in particular, a surface of the shaft 108 within the cutout 408 that is behind the pin 304, the latter surface acting as a fulcrum point for prying the cap off the bottle. Thus, in this example, the user would rotate the temple 107 to its open position as shown in FIG. 4, position the pin 304 underneath the cap, so as to grip the cap, and rest the surface of the shaft 108 that is in the cutout 408 against the top of the cap. In this embodiment, the pin 304 faces rearward. Thus, to remove the cap, the user would press or pull down on the top surface 402 of the shaft 402 (at a point rearward of the cutout), to rotate the shaft 108 about the fulcrum point within the cutout 408, and thereby pry the cap off the bottle.

In a further embodiment, the cutout 408 is alternatively located in the top surface 402 of the shaft 108 (and the pin 304 is also correspondingly located in the top surface within the cutout 408). This embodiment can be visualized by rotating the combination of the cutout 408 and the pin 304 180 degrees relative to the rest of the shaft, about the longitudinal axis of the shaft 108. The opening means would in that case point “upwards”.

The various embodiments of the invention described above allow a person to use eyewear such as a pair of sunglasses to easily and conveniently open a bottle, by removing its cap using an integrated and compact opener mechanism. The areas of the eyewear frame that are subject to the forces needed to remove the bottle cap are located in an area of the frame that does not diminish the natural shape, curvature, or look of the eyewear. These portions of the eyewear may be made of metal, plastic, or other material that is strong enough to withstand the forces and torque created when removing a bottle cap. For example, the pin 304 may be made of metal, while the shaft 108 could be made of another material. The pin 304 is used to represent any suitably shaped extension or claw that can grip underneath the bottle cap, to achieve the desired result of prying the cap off the bottle.

It can be seen that, in a general sense, some of the above-described embodiments of the invention have an opener mechanism, including a claw portion and a fulcrum portion, that is integrated into the temple in such a way that direct force can be applied to the top surface or the bottom surface of the temple's shaft, and not the sides of the shaft, to pry off the bottle cap. This allows the opener mechanism to take advantage of the strength and stiffness of a conventionally shaped temple shaft, which is taller in a vertical plane than its width in a horizontal plane. Indeed, it is more difficult to bend such a conventionally shaped shaft in the vertical plane than in the horizontal plane. The opener mechanisms depicted here may take advantage of such strength and stiffness, by being more discretely integrated into eyewear.

The invention is not limited to the specific embodiments described above. For example, the different tips 111 described above can be part of straight temples, as opposed to the skull temples (bent downward) shown in the figures. Also, the opener mechanism can be incorporated into both temples, as opposed to just one that is shown in the figures. Regarding the corner at which the frame front and the temple are connected to each other, this need not be a sharp change in direction but instead can be more rounded than shown in the figures. Accordingly, other embodiments are within the scope of the claims.

What is claimed is:

1. An apparatus comprising:
eyewear having a frame front and a temple connected to the frame front, the temple having an earpiece, a tip, and a structure having first and second segments, in the earpiece or at the tip, that define a substantially U or V shape, the first and second segments being adapted to grip a bottle cap and to allow the bottle cap to be pryed off its bottle.

2. The apparatus of claim 1 wherein the first segment is shorter and in front of the second segment.

3. The apparatus of claim 1 wherein the frame front comprises first and second eyepieces joined by a bridge.

4. The apparatus of claim 3 wherein the eyewear further comprises first and second lenses fixed in the first and second eyepieces, respectively.

5. The apparatus of claim 1 wherein the eyewear further comprises another temple connected to the frame front.

6. The apparatus of claim 5 wherein the eyewear further comprises a pair of hinges, the temples being connected to opposite sides of the frame front by the hinges, respectively.

7. The apparatus of claim 6 wherein the eyewear further comprises said another temple having an earpiece or tip which has a substantially U-shaped or V-shaped structure adapted to grip a bottle cap.

8. An apparatus comprising:
eyewear having a frame front and a temple connected to the frame front at a corner, the temple having an earpiece, the earpiece having a front surface that is closer to the corner than a rear surface and a tip which is substantially J-shaped to grip a bottle cap, the J-shaped tip having a curved segment with a left side and a right side and a vertical segment extending from the right side, the vertical segment having a left surface that extends from a surface of the curved segment and a right surface opposite the left surface.

9. The apparatus of claim 8 wherein the left side of the curved segment is reinforced relative to the right side.

10. The apparatus of claim 8 wherein the left surface, of the vertical segment of the J-shaped tip, is behind the front surface of the earpiece and in front of the right surface.

11. The apparatus of claim 8 wherein right surface, of the vertical segment of the J-shaped tip, is behind the front surface of the earpiece and in front of the left surface.

12. The apparatus of claim 8 wherein the frame front comprises first and second eyepieces joined by a bridge and aligned with the first and second eye orbital regions, respectively.

13. The apparatus of claim 12 wherein the eyewear further comprises first and second lenses fixed in the first and second eyepieces, respectively.

14. An apparatus comprising:
eyewear having a frame front and a temple connected to the frame front at a corner, the temple having an earpiece, the earpiece having a front surface that is closer to the corner than a rear surface and a tip which is U or V-shaped, one segment of the shaped tip having a pin positioned to grip a bottle cap together with another segment of the shaped tip.

15. The apparatus of claim 14 wherein the tip is such that the pin is behind the front surface of the earpiece and in front of said another segment of the shaped tip.

16. The apparatus of claim 14 wherein the tip is such that the pin is behind the front surface of the earpiece and behind said another segment of the shaped tip.

17. The apparatus of claim 14 wherein the frame front comprises first and second eyepieces joined by a bridge and aligned with the first and second eye orbital regions, respectively.

18. The apparatus of claim 17 wherein the eyewear further comprises first and second lenses fixed in the first and second eyepieces, respectively.

19. An apparatus comprising:
eyewear having a frame front and a temple connected to the frame front at a corner, the temple having
an earpiece,
means for removing a cap from a bottle, the removing means embedded in the temple between the earpiece and the corner,
a top surface, and
a bottom surface opposite the top surface, the top and bottom surfaces located between the corner and the earpiece.

20. The apparatus of claim 19 wherein the removing means comprises:
a cutout in the bottom surface, and
a pin embedded in the cutout to cooperate with the cutout in prying the cap off the bottle.

21. The apparatus of claim 19 wherein the frame front comprises first and second eyepieces joined by a bridge.

22. The apparatus of claim 21 wherein the eyewear further comprises first and second lenses fixed in the first and second eyepieces, respectively.

23. The apparatus of claim 19 wherein the removing means comprises:
a cutout in the top surface, and
a pin embedded in the cutout to cooperate with an inside surface of the cutout in gripping and lifting the cap off the bottle.
